(19) United States
(12) Patent Application Publication
(10) Pub. No.: US 2024/0206435 A1
(43) Pub. Date: Jun. 27, 2024

(54) SYSTEM AND METHOD OF HEATING LIVESTOCK BARNS USING MODULATING RADIANT EMITTER

(71) Applicant: SUPERIOR RADIANT PRODUCTS LTD., Stoney Creek (CA)

(72) Inventors: Gjergji File, Oakville (CA); Kevin Merritt, Burlington (CA)

(21) Appl. No.: 18/554,172

(22) PCT Filed: Apr. 1, 2022
(86) PCT No.: PCT/CA2022/050504

§ 371 Date: Oct. 5, 2023

Related U.S. Application Data
(60) Provisional application No. 63/171,269, filed on Apr. 6, 2021.

(51) Int. Cl. A01K 31/20

(52) U.S. Cl. CPC A01K 31/20

(57) ABSTRACT

There is provided a radiant brooder system. The radiant brooder system includes a multistage radiant brooder configured to emit radiant heat to a floor area to create a temperature zone. The multistage radiant brooder has a high output setting and a low output setting. The radiant brooder system also includes a black body sensor positioned to gather radiant energy data within the temperature zone, and a processor coupled to the blackbody sensor to receive the radiant energy data therefrom. The processor is operatively coupled to the multistage radiant brooder to control the operation of the multistage radiant brooder to the high output setting, the low output setting, or off in response to the received radiant energy data from the black body sensor.

### CROSS-REFERENCE TO RELATED APPLICATION(S)

This application is the national phase of PCT Application No. PCT/CA2022/050504 filed on Apr. 1, 2022, which in turn claims priority to U.S. Provisional Application No. 63/171,269 filed on Apr. 6, 2021, both of which are incorporated by reference herein in their entireties.

### TECHNICAL FIELD

This disclosure relates generally to radiant heating systems and, in particular, to radiant brooder systems for heating livestock in an agricultural building or barn.

### BACKGROUND

Brooding is the management of chicks after they're born and before their sale or movement to laying houses. The performance of a flock of broilers (i.e. chickens bred specifically for meat production) can be measured by growth rate, mortality, and feed efficiency. Typically, broilers experience a period of rapid growth early in their development (first four days), which is then followed by a slow rate of growth. Feed efficiency is much better in the first weeks of broiler production. The main factor affecting feed efficiency is the energy level of the feed. Because of the cost of energy-rich feedstuffs, chicken farmers prefer to maintain the same growth rate with lower energy level of the feed if possible.

An important non-dietary factor influencing feed conversion in chickens is the ambient temperature of the poultry house. The thermal comfort zone of a chicken is a range of temperatures at which the chicken does not have to actively regulate body temperature. That range varies with species, age, nutrition, and other stress factors.

Thus, there is a trade-off between energy provided by feed and fuel used for heating in farms operated in cold climates. The most economical temperature for a poultry house will typically depend on the relative prices of feed vs heating costs. When the calories from feed are used for warmth by the chicken, they are not converted to meat. At the same time, if temperatures are too high, broilers tend not to eat as much or may not eat at all. Much of the difference in performance of broiler flocks can be attributed to how well the in-house environmental conditions are managed, especially temperature, air, and litter quality.

Heaters, including radiant heaters (generally referred to as brooders), are traditionally used in agricultural buildings or barns (generally referred to as houses and largely for poultry, but also for hogs and cattle), and are commonly controlled using air temperature sensors. An issue with current radiant heaters used in such agriculture applications is that the heat distribution pattern upon the livestock is often inconsistent. This is due, at least in part, to the fact that the brooders are typically arranged to cover the entire area of the house. The houses can have low ceiling structures causing the direct radiant energy coming from the heater's emitters to be re-radiated from the floor, the ceiling, and the walls. The ceiling and the walls will thus radiate heat at wavelengths that are a function of their temperatures. The total radiant energy transmitted to the livestock will then be a combined result of the energy transmitted by all the facing surfaces. The air temperature and air velocity will have an additional contribution on the overall energy exchanged with the livestock. To accommodate for uneven heat distribution patterns, current heating systems rely on air temperature within the barn and cycle the radiant heater on and off according to air temperature readings.

Where radiant output is be concentrated in particular areas on the floor, livestock could be subjected to excessive or insufficient amounts of radiant heating. Further, where there are radiant “hot spots”, an updraft in the air can be created, which can cause inefficient airflows and mixing of cold and warmer air.

It is desirable to have a radiant brooder system that can more accurately and more evenly heat the floor (and hence the livestock) of an agricultural building despite external factors.

### SUMMARY

In one aspect of the present disclosure, there is provided a radiant brooder system comprising: a first multistage radiant brooder configured to emit radiant heat to a floor area to create a first temperature zone, the first multistage radiant brooder having a high output setting and a low output setting; a first black body sensor positioned to gather radiant energy data within the first temperature zone; and a processor coupled to the first black body sensor to receive the radiant energy data therefrom, and operatively coupled to the first multi-stage radiant brooder to control the operation of the first multistage radiant brooder to the high output setting, the low output setting, or off in response to the received radiant energy data from the first black body sensor.

In another aspect of the present disclosure, the above radiant brooder system further includes a second multistage radiant brooder, the second multistage radiant brooder being positioned adjacent the first multistage radiant brooder and coupled to the processor. The processor controls the first multistage radiant brooder independently from the second multistage radiant brooder.

In another aspect of the present disclosure, the above radiant brooder system further includes a solar air collector integrated into a wall of a building having the radiant brooder system, the solar air collector configured to preheat external air coming into the building using solar energy.

In another aspect of the present disclosure, there is provided a radiant brooder system for heating an agricultural building, the radiant brooder system comprising: a pair of multistage radiant brooders, each multistage radiant brooders configured to emit radiant energy to a floor area to create a first temperature zone, each multistage radiant brooder having a high output setting and a low output setting; a black body sensor positioned to gather radiant energy data within the first temperature zone of each multistage radiant brooder; a solar air collector integrated into a wall of the agricultural building, the solar air collector configured to preheat external air coming in-to the agricultural building using solar energy; and a processor coupled to each black body sensor to receive the radiant energy data therefrom, and operatively coupled to the pair of multi-stage radiant brooders to control the multistage radiant brooders in response to the received radiant energy data from the first black body sensor.

### BRIEF DESCRIPTION OF THE DRAWINGS

For a better understanding of the present disclosure, and to show more clearly how it may be carried into effect, reference will now be made, by way of example, to the accompanying drawings which show exemplary embodiments of the present disclosure in which:

FIG. 1 is a schematic plan view of a typical agricultural building showing an example of a current radiant brooding system where the chicken or poultry barn in question is divided into a center brooding chamber and two non-brooding end chambers.

FIG. 2 is a top perspective view of the chicken or poultry barn of FIG. 1.

FIG. 3 is a view of the barn of FIG. 2 with the roof removed.

FIG. 4 is a graph illustrating the irradiance level under a conventional brooder, measured in a plane 100 mm under the lowest component (dustpan).

FIG. 5 is a graph illustrating the temperature of the floor under a conventional brooder after one hour of operation and the irradiance flux (Btu/h/ft\hat{ }2) on the floor beneath the brooder.

FIG. 6 shows a typical air temperature and a typical air movement pattern of a cross-section of the barn along line 6-6 of FIG. 1, when exhaust fans are off.

FIG. 7 is an air temperature pattern of a cross-section of a central portion the barn along line 7-7 of FIG. 6, when exhaust fans are off.

FIG. 8 is an operative temperature pattern (combination of air temperature, MRT—Mean Radiant Temperature and air velocity) of a cross-section of a central portion the barn along line 8-8 of FIG. 6, when exhaust fans are off.

FIG. 9 is an air temperature pattern of a cross-section of the barn along line 6-6 of FIG. 1, when exhaust fans are on.

FIG. 10 is an air temperature pattern of a cross-section of a central portion the barn along line 10-10 of FIG. 9, when exhaust fans are on.

FIG. 11 is a graph illustrating a change in average outdoor temperatures experienced by an agricultural building or barn over a year on a typical northern hemisphere farm.

FIG. 12 is an air temperature pattern of a cross-section of the barn along line 6-6 of FIG. 1, when uncontrolled or asymmetric outside air enters the building due to wind effect on a side wall of the building.

FIG. 13 is a temperature pattern of a cross-section of a central portion the barn along line 13-13 of FIG. 12, when exhaust fans are off, and during windy weather when cold air enters the building due to pressure differences on different sides of the building.

FIG. 14 is a top perspective view of a temperature pattern on a portion of the floor of an agricultural building or barn in windy weather, and when the wind direction is facing the longest side of the building.

FIG. 15 is a side view of a multistage radiant brooder system in accordance with an embodiment of the present disclosure.

FIG. 16a is a side view of a typical radiant brooder in isolation with a portion of the reflector removed.

FIG. 16b is a side view of a radiant brooder in accordance with an embodiment of the present disclosure with a portion of the reflector removed.

FIG. 17 is a graph illustrating the irradiance flux on the floor when the multistage brooder of FIG. 15 is at high fire and at low fire.

FIG. 18 is a schematic view of a radiant heating system according to an embodiment of the present disclosure used in the barn of FIG. 1.

FIG. 19 is a schematic drawing showing the primary components of the radiant brooder system of FIG. 15 with additional sensors.

FIG. 20 is a side view of the radiant brooder system of FIG. 19 showing a solar air collector integrated into the barn.

FIG. 21 is a graph illustrating an average daily solar radiation over a year in a typical northern hemisphere location.

FIG. 22 is a graph illustrating a solar air heating potential to be collected over a year by the solar air collector of FIG. 20.

### DETAILED DESCRIPTION

The present disclosure may be embodied in a number of different forms. The specification and drawings that follow describe and disclose some of the specific forms of the present disclosure.

As noted above, one of the main requirements for the healthy development of young chicks is heat or warmth.

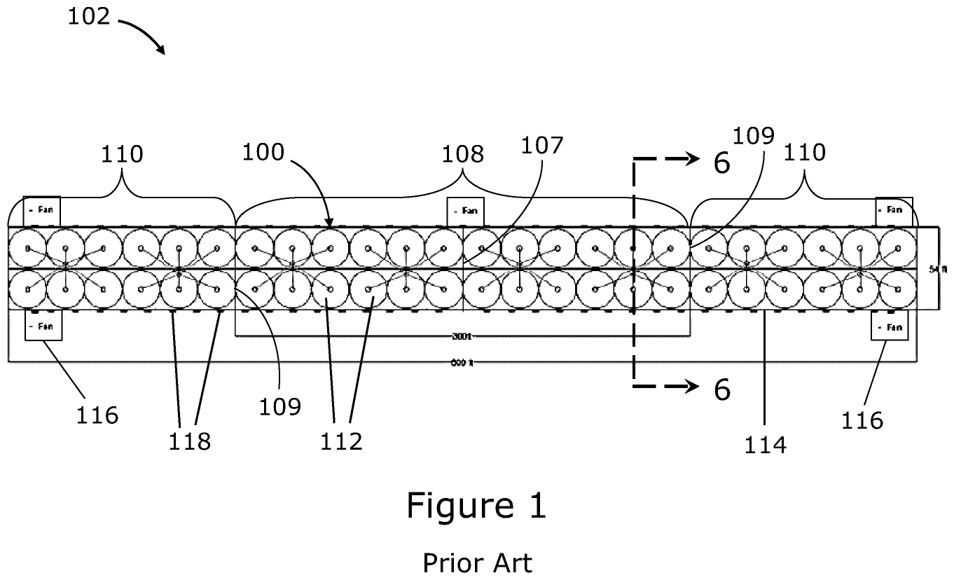

An existing or conventional brooder heating system 100, used in a conventional agricultural building or barn 102 for brooding, is shown in FIGS. 1 to 12.

Conventional chicken barns are typically buildings with a low ceiling 104 and a wide footprint or floor area 106. For example, in the embodiment depicted in FIG. 1, barn or building 102 is 54 ft×600 ft×11 ft, with 9 ft side walls, with a 1/12 roof slope and a 13.5 ft centre ceiling height. Thus, the building size would have an approximate internal volume of 54′×600′×11.25′=364,500 cubic feet.

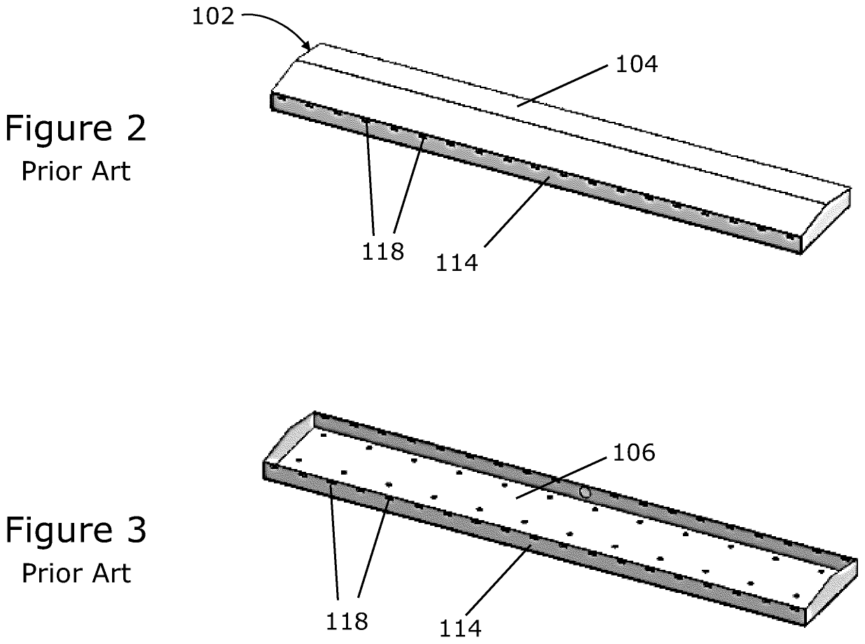

In such a case, the centre portion of building 102 is often used for brooding. A curtain 109 may be dropped down 150 ft on each side from a centerline 107 of building 102, separating a center brooding chamber 108 from non-brooding side chambers 110. A model of central house or brooding chamber 108 is shown in FIG. 2 with ceiling 104 and in FIG. 3 without ceiling 104. Of course, conventional chicken barns and brooding chambers may have different dimensions than those described herein.

As depicted, a typical conventional brooder heating system 100 includes multiple conventional brooders 112 (for example, 24 brooders 112 in two rows inside of center brooding chamber 108, and 12 brooders 112 in two rows in each of non-brood end chambers 110 in the embodiment shown in FIG. 1. Brooders 112 may be arranged in parallel or may be staggered. Walls 114 of barn 102 are typically 6″ thick with batt insulation and plywood or similar interiors. Ceiling 104 often has blown-in insulation (typically, R21-R30 or more depending on the climate). Drop curtains 109 may be formed from heavy black or clear plastic, or the like.

Barn 102 may also include exhaust fans 116. In the embodiment shown, four exhaust fans 116 are positioned in the four corners of barn 102, and one is positioned in on side at the centre. Fresh air inlets 118 are commonly positioned along walls 114.

Such barns would typically house 0.8-0.9 birds or poults per sq. ft. of floor area. Thus, the depicted barn 102 in the attached drawings could hold (54′×600′)/0.85=˜38,000 poults or chickens. In temperate or colder climates, each bird usually requires about 1 btu/hr of heat during its first week.

For the first week of the life of a new chick, a typical air exchange of about 0.05 CFM per bird, (0.05×38,000=1,900 CFM in the case of barn 102) is required. After a week of age, poults tend to require up to 0.08 CFM per bird, (0.08×38,000=3,040 CFM in the case of barn 102). To achieve the required air exchange, chicken farmers typically run exhaust fans 116 in non-brood chambers 110. The brood chamber is typically ventilated by drawing air in through brood chamber inlets 118, and through cracks around the curtains, and then directing it to the end of the barn, where it exits the building.

Centre brood chamber 108 temperatures typically need to be maintained at approximately 90° F. on day 1, and at approximately 86° F. by day 7 of a poult's life. Non brooding chamber areas 110 on the other side of curtains 109, can often be considerably cooler as they house more mature birds. On freezing days those chambers could be as cold as 45° F. depending on the variety of bird being housed, the age of the birds, etc.

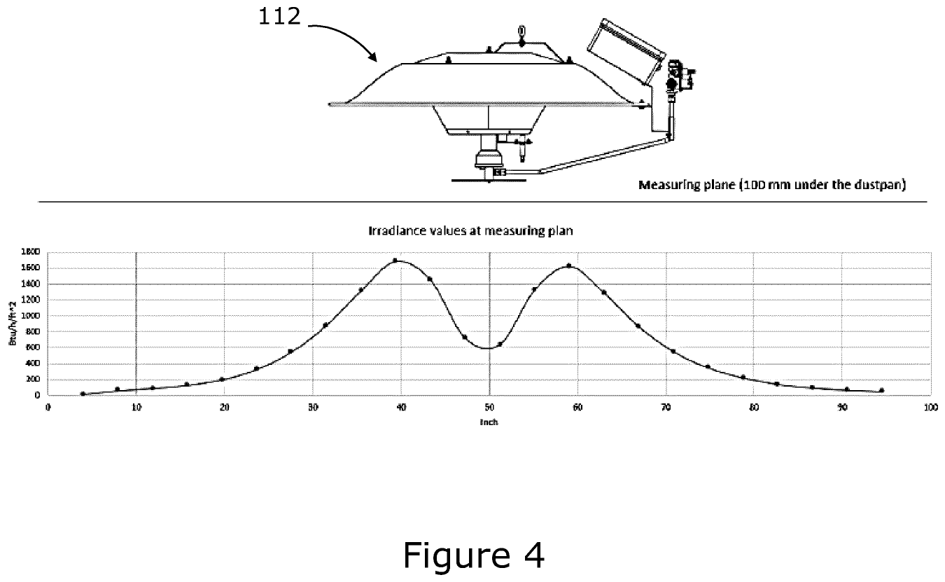

Conventional brooders 112 are often radiant brooders can commonly have a 40 MBH input rate and are often installed approximately 5 to 6 ft. above floor 106. The irradiance under brooder 112, measured in a plane about 100 mm under the lowest component (dustpan), is shown in FIG. 4.

Brooders 112 create a directional thermal radiant field with a coverage area of 25 to 40 ft., depending on weather conditions at the specific location of barn 102.

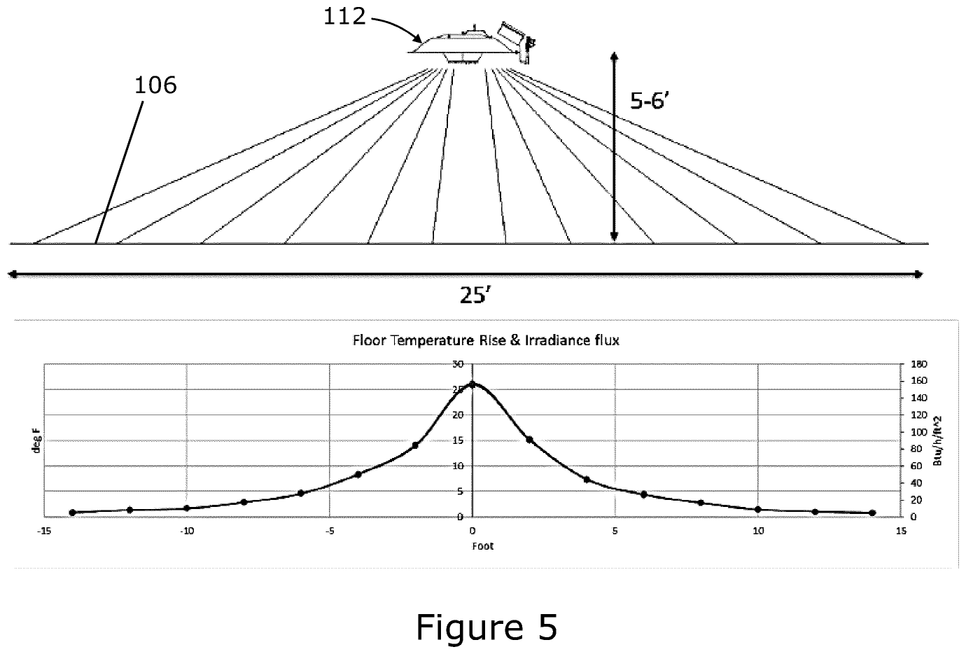

The temperature rise of floor 106 after one hour operation at 40 MBH commonly has a profile as shown in FIG. 5. A low wave re-radiation and reflection between floor 106, ceiling 104, and walls 114 contribute to the radiant field inside building 102.

Typically, one heating zone can be served by six brooders 112. The brooders are turned on together if the sensed air temperature for that zone is lower than the required temperature. Thus, under this scenario, heat input in one zone will be 6×40=240 MBH. In the described system, the coverage area of six brooders will be 6×25×25=3750 sq. ft. The number of birds in one zone will be approximately 0.8×3750=3,000 poults. The heat per bird will thus be 240,000 Btu/h÷3000=80 Btu/h/bird.

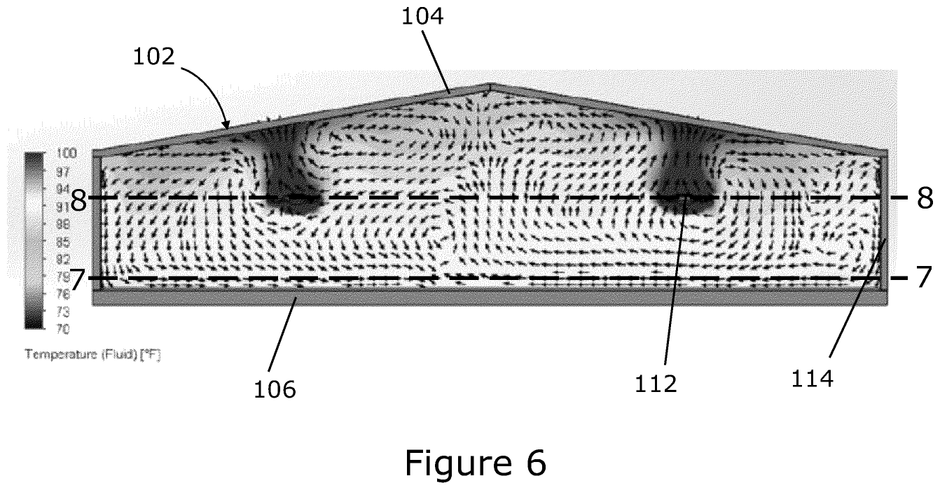

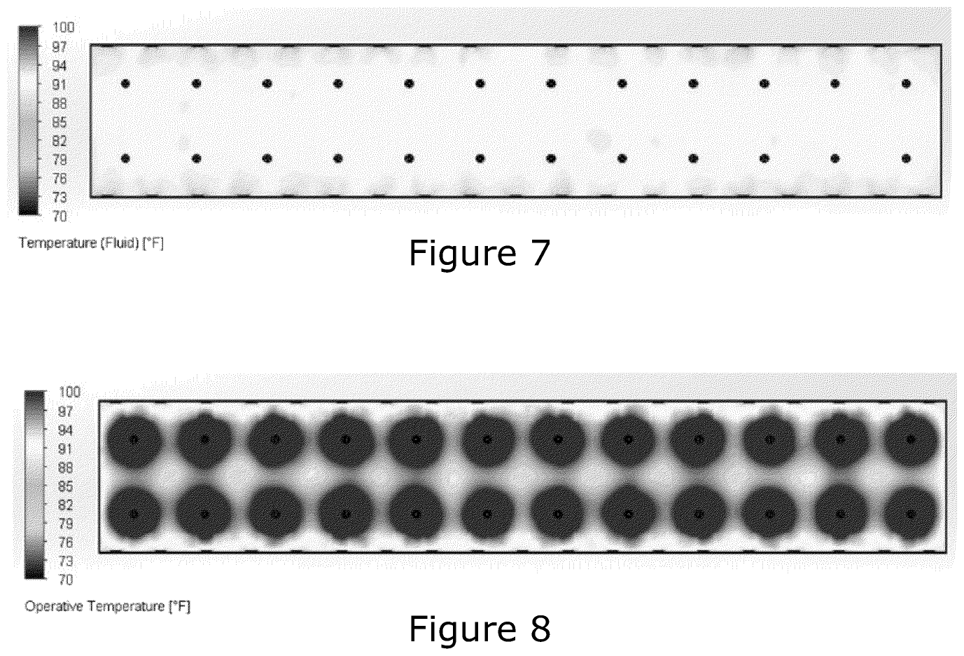

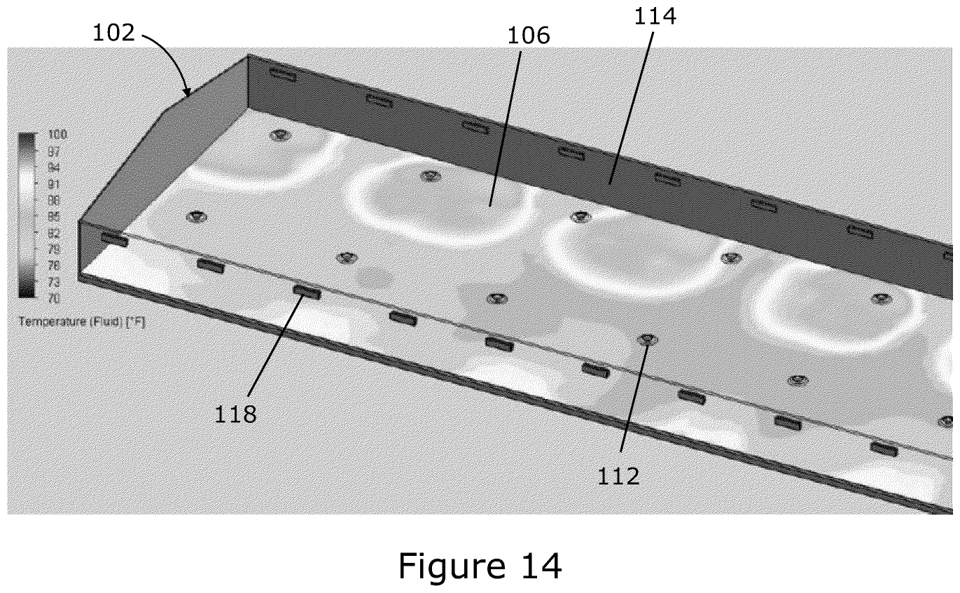

FIGS. 6-10 and 12-14 illustrate typical air operative temperature patterns within centre brooding chamber 108, and barn 102 in general. When conventional brooder heating system 100 is engaged, and exhaust fans 116 turned off, an air temperature pattern in centre brooding chamber 108 as shown in FIG. 6, and temperature stratifications as shown in FIGS. 7 and 8, can be expected.

Typical or optimal temperature patterns approximately 2″ above floor 106 in centre brooding chamber 108 are shown to be relatively even and consistent when exhaust fans 116 are off. When the comfort of the chick is a priority, floor-level temperatures are important.

Proper air flow and ventilation is required in brooding chambers for a number of reasons. The presence of contaminants in the air (such as ammonia, dust particles, microorganisms, spores, etc.) and litter quality are directly linked to the mortality and growth rate of chickens. The moisture content of the air and floor litter impacts particle generation. If the floor litter is excessively dry, air and bird movement tends to increase the amount of particles in the air. When poultry droppings decompose in the presence of moisture and heat, ammonia is released into the air. In other cases, areas of excessive moisture will lead to soggy litter, which will lead to reduced broiler performance and quality.

Currently, managing air contaminants is largely accomplished through the ventilation system, using exhaust fans 116 and fresh air inlets 118.

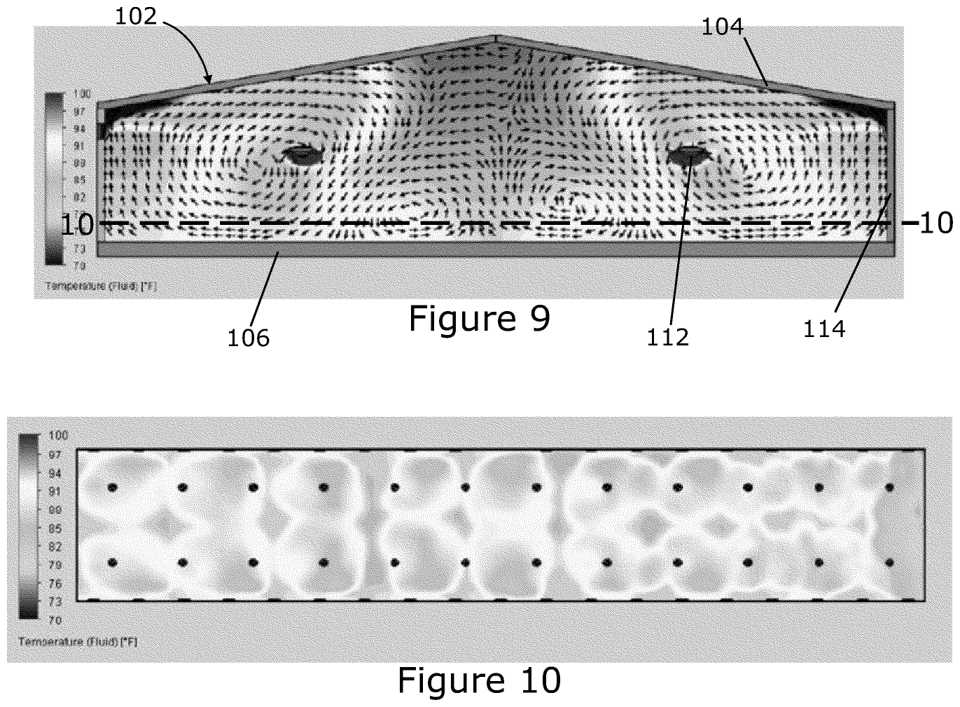

When exhaust fans 116 are on (which may comprise of on and off cycles of varying durations), the air floor temperature can be reduced to under the required temperature. This is often caused by a combined effect of cold air coming from inlets 118 and the location of the curtains relative to the active fan, creating a different heat demand on both sides of centre brooding chamber 108. As best seen in FIGS. 9 and 10, the heating pattern on floor 104 is more uneven than in FIG. 7, and contains noticeable hot and cold spots when the fans are on. Cold air coming from non-brooding end chambers 110 through curtains 109, may also create cold areas as shown on the right side of FIG. 10.

The cold air coming from inlets 118 may be directed toward the ceiling and is mixed with the warm inside air. The mixing of air with different temperatures (and hence densities) can create an air flow dynamic that affects the air temperature on the floor where the birds are located. Since hot air tends to collect at the top, central portion, of the house or brooding chamber, fans can be used move and use that collected heat.

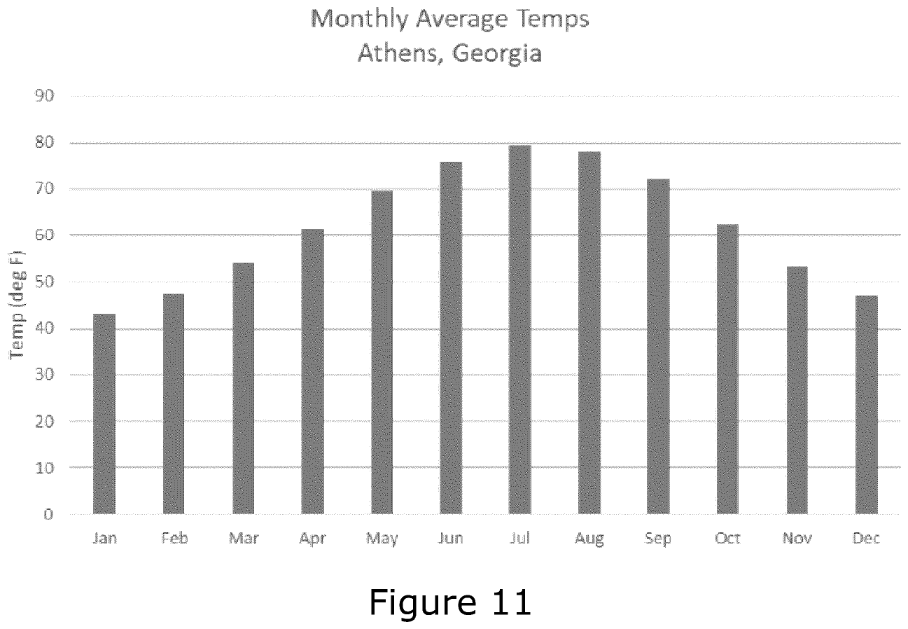

When the weather rapidly changes in terms of temperature and/or wind, it is often a challenge to smoothly transition the load demand so the birds are not subjected to drastic changes in temperature. FIG. 11 illustrates an example of a change in outdoor temperature over an average year in a typical location in the northern hemisphere. The heat loss throughout the year is a function of outdoor temperature. Thus, a different heat load is required in different months. Conventional brooder heating system 100 is typically designed to provide sufficient heat during the coldest months, meaning that the heating system is often oversized for many months of the year, resulting in shorter cycle times, potential overheating and/or non-uniform heating of the poults in months of less severe temperatures.

To eliminate overheating, farmers will often raise the elevation of a brooder using an adjustable hanging apparatus. However, through use of a multistage brooder, the need for an adjustment of the brooder height can be avoided, reducing the need for laborious adjustments while providing a means to automate the heat delivered to match the required demand.

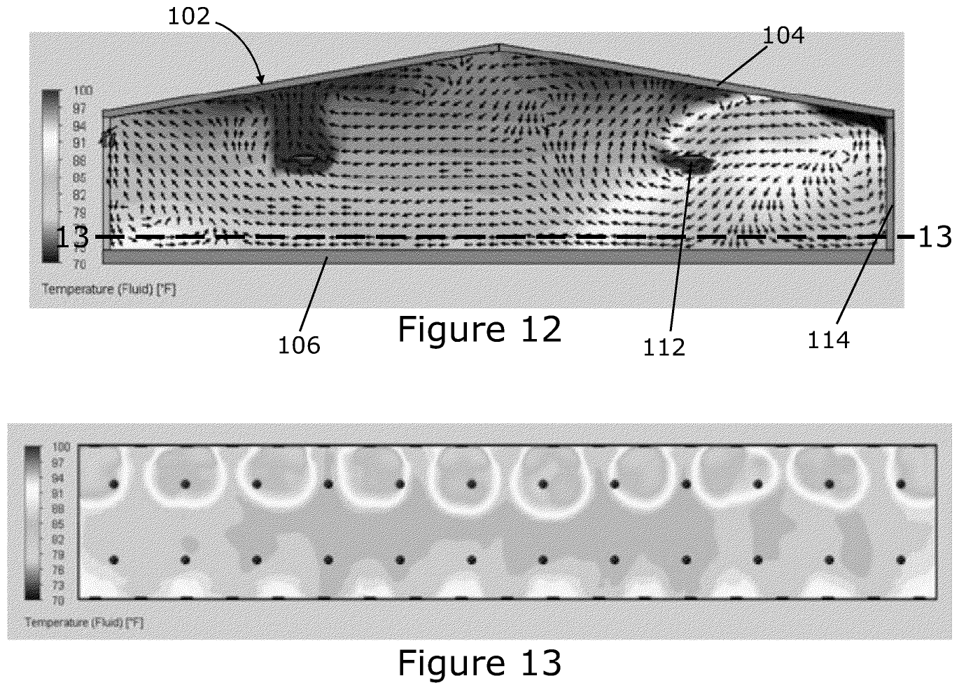

As well, when outdoor air enters centre brooding chamber 108 through fresh air inlets 118, its entry is usually uncontrolled. This tends to create an asymmetry on the air temperature profile and heat demand on floor 106 (see FIGS. 12-14) which can create even greater, and more asymmetrical, hot and cold spots on floor 106. In windy weather conditions, the outdoor air entering the building can cause non-uniform heat demand on the floor. Cold incoming air mixes with humid air inside barn 102, which can cause condensation, and which can result in local soggy litter that will tend to reduce the useful area in barn 102, reduce broiler performance, and contribute to poor paw quality. The present system and method may be used to combat such conditions.

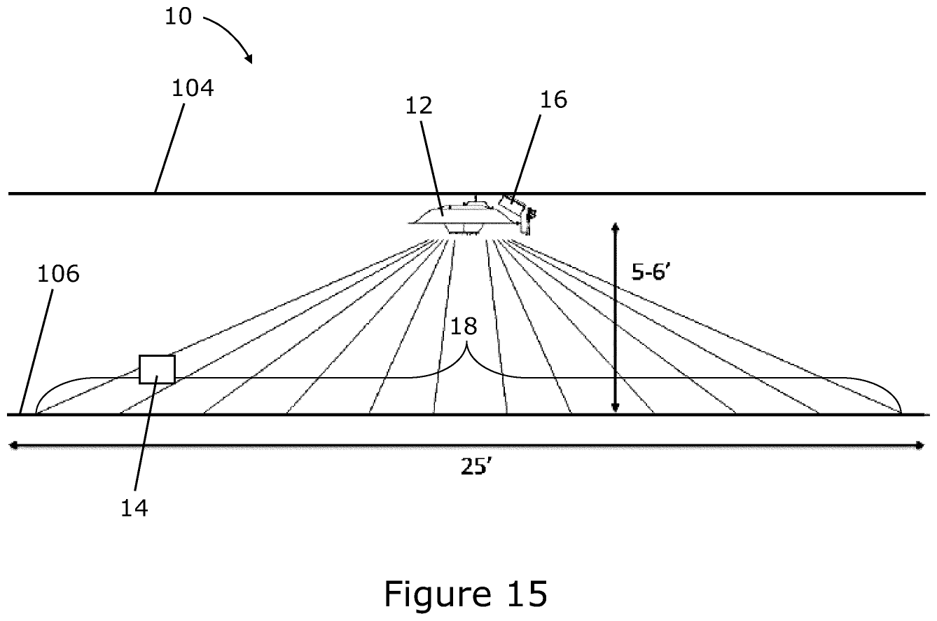

Thus, in response, the present disclosure provides a radiant brooder system 10 for barn 102, with a low ceiling 104 and a floor 106 with a large footprint (see FIGS. 15-22). Radiant brooder system 10 includes a first multistage radiant brooder 12, a first black body sensor 14, and a processor 16 coupled to both multistage radiant brooder 12 and black body sensor 14.

Similar to conventional brooder 112, first multistage radiant brooder 12 is secured to or hung from ceiling 104 of barn 102 and is configured to emit radiant heat to floor 106 to create a first temperature zone 18. In that regard, first multistage radiant brooder 12 has a reflector 11 with a generally parabolic shape, and a generally frusto-conical shaped emitter 13 positioned therein. First temperature zone 18 is the area under first multistage radiant brooder 12 onto which radiant energy is emitted.

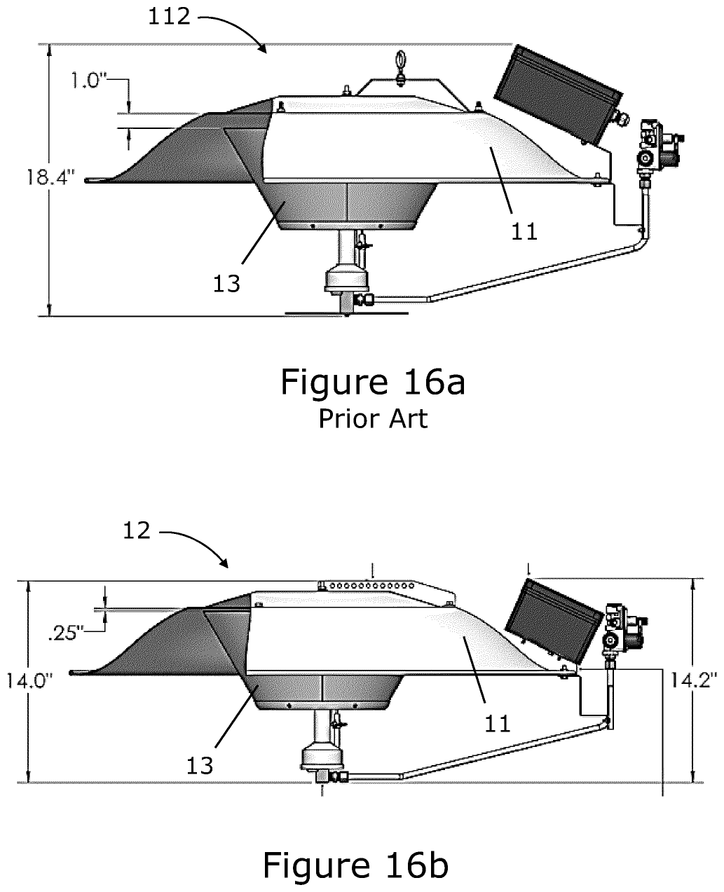

Unlike conventional brooder 112, the radiant efficiency of multistage radiant brooder 12 may be increased by optimizing the distance between emitter 13 and reflector 11. Emitter 13 in a conventional brooder typically is positioned approximately 1 inch from its reflector 11 (see FIG. 16a). In the case of multistage radiant brooder 12, emitter 13 can be positioned approximately 0.2-0.3 inches from reflector 11. In one embodiment emitter 13 is positioned approximately 0.25 inches from reflector 11 (see FIG. 16b). Through positioning the reflector in this manner, approximately 70-80% of the surface of emitter 13 may be positioned inside parabolic reflector 11. In one embodiment, approximately 75% of the surface of emitter 13 is positioned inside parabolic reflector 11. Arranged in this way, it has been found that the radiant efficiency of multistage radiant brooder 12 can be increased by approximately 25%, or in some cases potentially up to 40 to 50%.

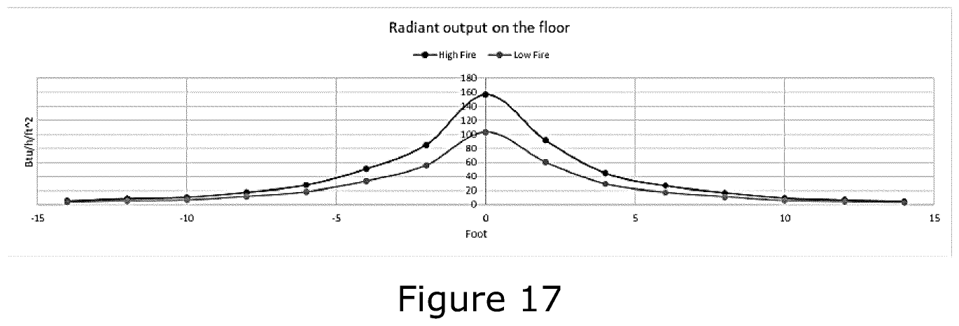

First multistage radiant brooder 12 is a modulating or multistage brooder that has a high output (or high fire) setting and a low output (low fire) setting. FIG. 17 is a graph illustrating the radiant output on floor 106 that a typical multistage radiant brooder 12 can emit in its low fire setting and its high fire setting.

The variable output (modulating and/or two stage) feature helps to address the issue of matching required heat demand with the load provided. The variation of heater output is limited by the radiant efficiency of the low fire setting. The characterization of the irradiance flux on floor 106, at variable inputs, for multistage radiant brooder 12, allows for a more precise heating control. Multistage radiant brooder 12 in the present embodiment may be a gas fired radiant brooder.

One or more black body sensors 14 are positioned to gather radiant energy data within first temperature zone 18. Black body sensors have a thermal mass that absorbs radiant energy to indicate how much energy is being received by the black body. The sensors do not measure temperature per se. The one or more black body sensors 14 may be positioned at various locations within first temperature zone 18, but at least one is preferably positioned where the poults are located (i.e. at chicken level). In that manner, black body sensor 14 mimics the body of a chicken and acts as an indicator of the amount of radiant energy absorbed by, or in some cases radiated from, the chicken's body. For example, black body sensor 14 may be positioned at least 10 feet away from the center of brooder 12 and approximately 2 feet above floor 106. Positioning black body sensor in this manner helps to ensure that it will receive the irradiance coming from brooder emitter 12, and from other surrounding objects and/or surfaces. It will also be appreciated that in some instances the output from black body sensor 14 may be affected by the local air temperature and the local air velocity as well.

Radiant brooder system 10 may further include one or more air temperature sensors 15 positioned to gather the temperature of the air within first temperature zone 18. Air temperature sensors 15 may be positioned proximate one or more black body sensors 14 at various locations. An air temperature sensor may also be positioned where the poults are located (i.e. at chicken level).

Processor 16 is coupled to black body sensors 14 and air temperature sensors 15 to receive the radiant energy and air temperature data therefrom. Processor 16 is operatively coupled to first multistage radiant brooder 12 to control and turn first multistage radiant brooder 12 to its high output (high fire) setting, low output (low fire) setting, or to its off setting in response to the received radiant energy data from first black body sensor 14 and the received air temperature data from air temperature sensors 15.

From the radiant energy data, processor 16 determines whether radiant energy from multistage radiant brooder 12 is needed to increase the chickens' body temperature. Depending on how much heat is required, and the rate of heat dissipation (i.e. cooling) of the chickens' bodies, multistage radiant brooder 12 will be cycled through its high and low settings.

In this manner, radiant brooder system 10 may be engaged to produce radiant energy that is required by the chickens based on their predicted body temperature, and combined radiant heat, air temperature and velocity, rather than based on the temperature of the surrounding air. As noted above, reliance of conventional chicken heating systems on air temperature measurements does not account for radiant heating or cooling of the chickens' bodies that may be occurring.

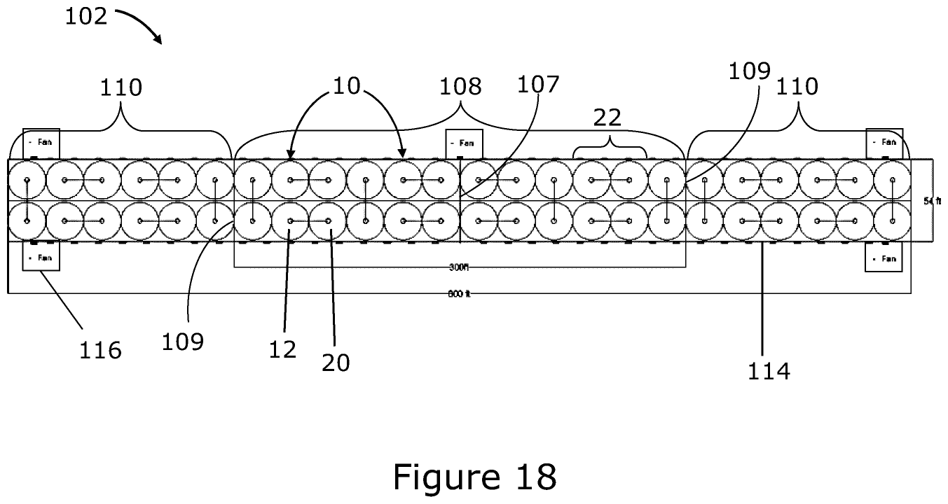

While radiant brooder system 10 is described as comprising one multistage radiant brooder 12, radiant brooder systems 10 may further include a second multistage radiant brooder 20, where second multistage radiant brooder 20 is positioned adjacent first multistage radiant brooder 12 and is also coupled to processor 16 (see FIG. 18). In certain applications, processor 16 can control first multistage radiant brooder 12 independently from second multistage radiant brooder 20. For example, if desired, processor 16 may only turn on one multistage brooder at a time, or turn one multistage brooder on to its low fire setting, while the other multistage brooder is turned to its high fire setting.

In such cases, radiant brooder system 10 may further comprise a second black body sensor that is positioned to determine radiant energy data in a second temperature zone created by second multistage radiant brooder 20. Processor 16 would be coupled to the second black body sensor to receive the radiant energy data therefrom, and would be configured to control second multistage radiant brooder 20 in response to the received radiant energy data from the second black body sensor.

Multiple radiant brooder systems 10 may be used in barn 12 as part of its overall heating system. As shown in FIG. 18, the multistage radiant brooders may be positioned adjacent to one another in two rows.

In an alternate embodiment, first and second multistage radiant brooders 12, 20 may form a first pair of radiant brooders 22, where processor 16 is configured to control first and second multistage radiant brooders 12, 20 together in tandem to collectively create first temperature zone 18. In such a case, radiant brooder system 10 may further include a second pair of radiant brooders 22, and a second black body sensor positioned to determine radiant energy data in a second temperature zone created by the second pair of radiant brooders. Processor 16 may then be coupled to the second black body sensor to receive the radiant energy data therefrom. Processor 16 may also be operatively coupled to the second pair of radiant brooders to control operation of the second pair of radiant brooders independently from the first pair of radiant brooders.

Radiant brooder system 10 may include a third pair of radiant brooders 22, and a third black body sensor positioned to determine radiant energy data in a third temperature zone created by the third pair of radiant brooders. Processor 16 may be coupled to the third black body sensor to receive the radiant energy data therefrom. Processor 16 may be operatively coupled to the third pair of radiant brooders to control operation of the third pair of radiant brooders independently from the first and second pairs of radiant brooders. In such a case, the multistage radiant brooders may also be positioned adjacent to one another in rows, as shown in FIG. 18.

When multiple radiant brooder systems 10 are used together in conventional barn 12, control of the heating appliances can be decentralized by monitoring the local temperature of the correlated temperature zone, and activating multistage radiant brooders 12 based on temperature needs. This provides a higher resolution for localized heating of floor 106 that can help to avoid creating hot or cold spots, as the heat load will more closely match the local demand.

It will be appreciated that the use of radiant heaters as described can allow for lower room air temperatures. This helps to reduce building heat loss and can save fuel during brooding periods when young broilers need high temperatures.

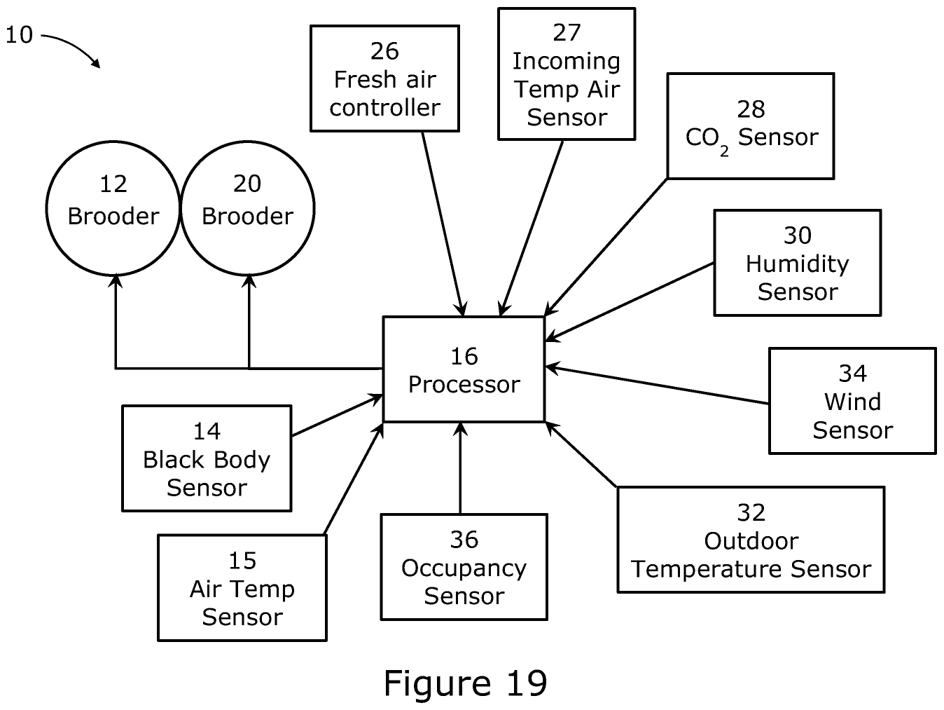

FIG. 19 illustrates a schematic of radiant brooder system 10 with additional sensors and features.

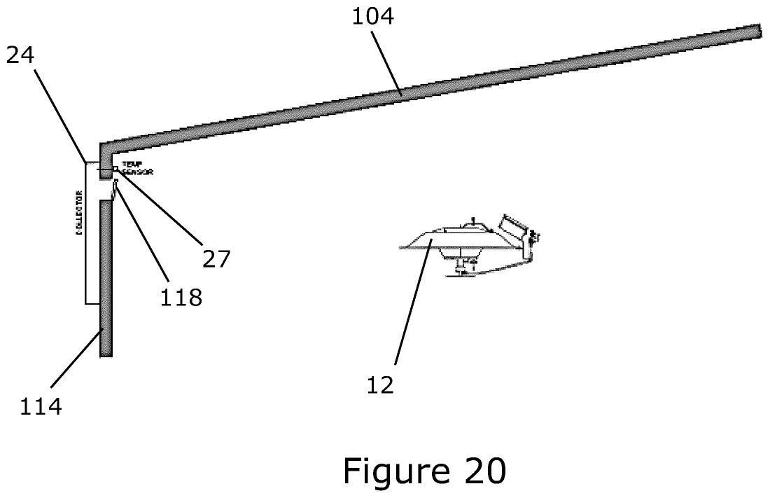

One such additional feature is a solar air collector 24 that may be integrated into wall 114 of barn 102 (see FIG. 20). As noted above, heating demands are effected by the temperature of fresh air coming into barn 102 for ventilation.

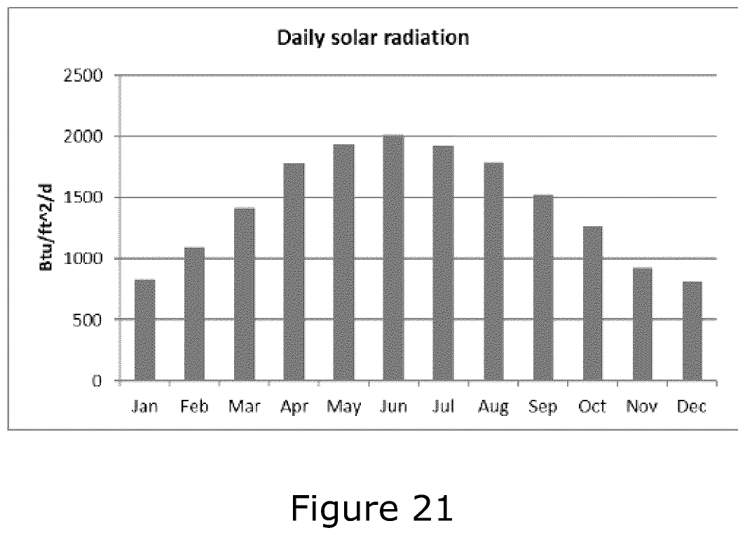

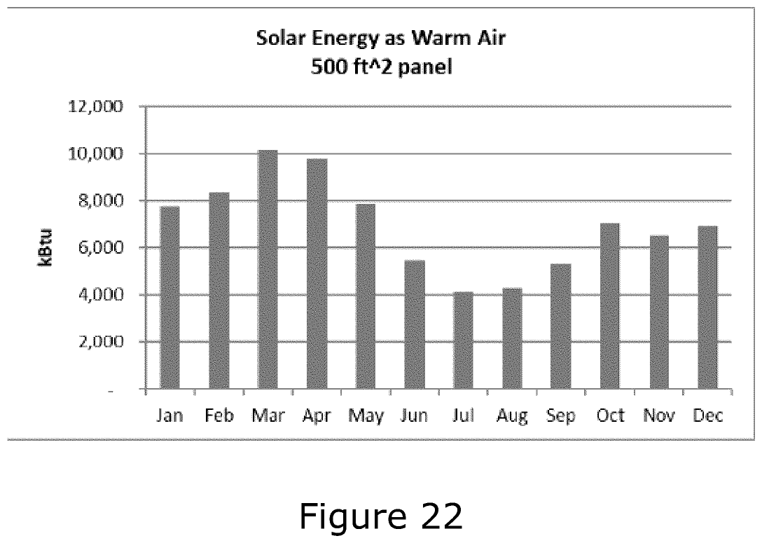

Thus, solar air collector 24 may be configured to preheat external ventilation air coming into barn 102 using solar energy. In an embodiment, solar air collector 24 is a solar air heater based on a perforated glazing technology (PGT) that can utilize up to 70% of the solar energy by preheating the ventilation air. While the efficacy of solar air collector 24 will depend on the amount of sunlight it can receive, it can often provide up to 25% of the heat demand for preheating the incoming ventilation air. FIGS. 21 and 22 are graphs illustrating an example of the potential heat that can be collected by a 500 sq. ft. PGT panel the United States. As well understood by the skilled person, warmer incoming air reduces the heating requirements on multistage radiant brooders 12, 20. Typically, solar air collectors 24 may be installed on the south side of house or brooding chamber 108, where more solar exposure is present (in northern hemisphere installations). This may cause an asymmetric incoming air temperature through fresh air inlets 118 on both sides of brooding chamber 108.

Radiant brooder systems 10 may also include a variable fresh air controller 26 and an incoming air temperature sensor 27 that may be secured proximate to solar air collector 24. Variable fresh air controller 26 can be configured to control and determine the amount of the preheated incoming external air that is entering barn 102 (i.e. the ventilation rate). Incoming air temperature sensor 27 measures the temperature of that incoming air. Processor 16 may be coupled to variable fresh air controller 26 to control the amount of incoming air and to receive the temperature of the incoming air from incoming air temperature sensor 27.

In some applications, the operation of radiant brooding system 10 can be affected by the internal air ventilation sequence (which can typically be 4.5 minutes off followed by 30 seconds on). When solar air collector 24 is installed (usually only on one side of brooding chamber 108), the temperature of the incoming air through solar air collector 24 will typically be higher than the outdoor air temperature. This may result in an asymmetric heat demand between areas with and without solar air collector 24. To minimize this potential effect, the outdoor air temperature and the air temperature coming through solar air collector 24 can be monitored. This information can then be processed, together with data from other sensors, and be used in the control strategy of the individual brooder's operation.

Radiant brooder system 10 may further include an outdoor temperature sensor 32 configured to determine an ambient temperature outside barn 102. Processor 16 would then be coupled to outdoor temperature sensor 32 to receive the outdoor ambient temperature therefrom. The outdoor air temperature may be used to determine the response of radiant brooder system 10 as function of the season (eg. winter or summer).

Using a combination of the above features, the poults may be warmed more effectively, while at the same time reducing annual operating costs.

Animals, such as chickens, tend to absorb about 30 to 40% of their heat through convection and about 60 to 70% by radiation. The conventional systems that measure and control agriculture heating using air temperature sensors, effectively control the heat applied or made available to the livestock on the basis of 30 to 40% of the livestock's heat intake. They effectively ignore the greater portion of 60 to 70% of the energy that is absorbed by radiation when it comes to decisions on when and for how long to operate a heating system.

Using radiant brooder system 10 can allow for higher efficiency and a greater reliance on radiant heat delivered to the poults, which can help to reduce operating costs. It is estimated that in some cases, utilizing the above described multistage radiant heaters 12, 20 and solar air collectors 24 can produce approximately 10% savings in annual operating costs.

Typically, conventional radiant brooders 112 used in the poultry houses operate at about 35-40% radiant efficiency, such that only 35-40% of the heat input is directed to the floor. The rest is released as a convective heat and is accumulated as warm air at or near the top of the brooding chamber. To account for that relatively low efficiency rating, others have suggested modifying the input rate (for example from 40 MBH to 42 MBH). However, such modifications largely serve to merely increase overall heat output and do not address efficiency, meaning that while more radiant energy may be directed to the floor, more energy is also lost to convective heat that reports to the upper portion of the brooding chamber and more energy is consumed.

In contrast, the applicant has found that utilizing radiant brooder 12, 20 as described above, a 40 MBH radiant brooder operating at 40% efficiency delivers approximately 16 MBH radiant heat to the floor. A 36 MBH radiant brooder 12, 20 operating at 50% radiant efficiency delivers approximately 18 MBH radiant heat to the floor.

Table 1 below sets out examples of how such savings may be realized.

TABLE 1

| | | High Efficiency | Low Efficiency | Differences |
|---|---|---|---|---|
| Radiant efficiency of brooder | | 50.0% | 40.0% | 25.0% |
| Input Rate | Btu/h | 36,000 | 40,000 | |
| Number of units | n | 24 | 24 | |
| Total installed input | Btu/h | 864,000 | 960,000 | −10.0% |
| Covered area (25′ × 25′) × n | ft\hat{ }2 | 15,000 | 15,000 | |
| Installed heat per ft\hat{ }2 | Btuh/ft\hat{ }2 | 58 | 64 | |
| Ventilation 2.5 cfm per 1000 Btu/h | cfm | 2,160 | 2,400 | |
| Annual Operating hours (heating season) | hours | 1000 | 1000 | |
| Heat on the floor | Btu/h | 432,000 | 384,000 | 12.5% |
| Average radiant heat intensity on the floor | Btu/h/ft\hat{ }2 | 29 | 26 | |
| Outdoor temp | deg F. | 30 | 30 | |
| Indoor temperature | deg F. | 85 | 90 | |
| Heat required for heating fresh air | Btu/h | 130,680 | 171,600 | −23.8% |
| Convective heat released | Btu/h | 301,320 | 404,400 | |

Similar to its response to radiant energy data from black body sensors 14, processor 16 can activate or cycle first multistage radiant brooder 12 between its high and low settings when the external temperature falls below a predetermined threshold to help maintain a more consistent heat profile across the interior of barn 102. For example, when the external temperature is low (i.e. during winter), multistage radiant brooder 12 next to wall 114 may be set to its high fire setting, while interior multistage radiant brooder 12 may be set to their low fire settings. Providing heat to account for a “cold external temperature” reading can also help to reduce the radiant heat loss that the birds may be exposed to in the event that the air immediately adjacent to a wall is considerably colder than their body temperatures.

Radiant brooder system 10 may also include a humidity sensor 30 to sense humidity levels in barn 102, and/or a carbon dioxide sensor 28 to sense carbon dioxide levels in barn 102. Processor 16 may be coupled to humidity sensor 30 to receive the humidity levels so as to help control humidity within barn 102. Processor 16 may also be coupled to carbon dioxide sensor 28 to receive the CO₂ levels so as to help control CO₂ levels within barn 102. To that end, processor 16 may engage multistage radiant brooders 12, 20 heat the interior of barn 102, evaporate the moisture, and expel it and/or the carbon dioxide from barn 102 by activating exhaust fans 116.

Radiant brooder system 10 may further include a weather/wind sensor 34 that is configured to determine wind direction and speed outside barn 102. Processor 16 may then be coupled to wind sensor 16 to receive the wind speed and direction therefrom. As noted above, wind conditions tend to cause non-uniform heat demand on floor 106. Processor 16 can be programmed to monitor the effects of wind speed and direction and to take into account the resulting wind cooling effect when cycling multistage radiant brooder 12.

It will be appreciated that the described disclosure not only provides an enhanced physical environment for chickens, but that it also presents the ability to reduce energy consumption and costs.

However, with radiant brooder system's 10 variable radiant heating feature and decentralized zoning control, the activation and fire level of multistage radiant brooders 12, 20 can be controlled based on the local floor temperature, and/or black body sensor readings, and/or wind sensor readings, and/or data from incoming air temperature sensor 27. In one example with respect to barn 102, if, based on the various sensor readings, one third of multistage radiant brooders 12, 20 were set to run at high fire with re remaining brooders are set to run at their low fire, there could be potential operating savings of up to 5% through the use of two stage operation and the decentralization of the heating controls. Wind also tends to result in a non-uniform heat demand on floor 106. This effect can be significant as, depending on the location of barn 102, windy conditions can exist during up to 30% of a year. Thus, the potential operational savings may be up to 5% due to use of the present multistage radiant brooders 12, 20 and the described radiant brooder system 10.

Table 2 and Table 3 provide examples of high and low fire operation costs, when weighting their contributions when running multistage heater under non-uniform heat demand caused by windy conditions.

TABLE 2

| | | High Fire | Low Fire |
|---|---|---|---|
| Input Rate | Btu/h | 40,000 | 30,000 |
| Number of units | n | 24 | 24 |
| Total Installed input | Btu/h | 960,000 | 720,000 |
| Annual Operating hours | hours | 1000 | 1000 |
| (heating season) | | | |
| Heating | | | |
| Propane Heating value | Btu/lb | 21,622 | 21,622 |
| Fuel used (1 gal = 6.7 lbs) | Gal/h | 6.63 | 4.97 |
| Propane price | $/gal | $1.65 | $1.65 |
| Annual Fuel Cost | $/yr | $10,934.14 | $8,200.60 |

TABLE 3

| Only one third of heaters will run at High Fire | | 0.33 | 0.67 | | | |
|---|---|---|---|---|---|---|
| Windy conditions occurance | 10% | $3,644.71 | $5,467.07 | $9,111.78 | $1,822.36 | $182.24 |
| | 20% | $3,644.71 | $5,467.07 | $9,111.78 | $1,822.36 | $364.47 |
| | 30% | $3,644.71 | $5,467.07 | $9,111.78 | $1,822.36 | $546.71 |
| | | High Fire | Low Fire | Annual Fuel | Annual | Annual |
| | | | | Usage (⅔ | Savings | Savings at |
| | | | | Low Fire) | relative to all | windy |

Radiant brooder system 10 may also include an occupancy sensor 36. Occupancy sensor 36 could be configured to determine the approximate number of animals (in this case, chickens) located within temperature zone 18. Processor 16 may be coupled to occupancy sensor 36 and further configured to calculate the amount of heat required from first and second multistage radiant brooders 12, 20 to maintain the body temperatures of the number of sensed animals within a pre-determined range.

For example, processor 16 could calculate the net loss of body heat lost by the chickens base on the air temperature, wind load, etc. and then calculate an appropriate amount of additional or make-up heat that the chickens require. These determinations could then be used, together with the black body sensor readings, to control the cycle of first and second multistage radiant brooders 12, 20, either collectively or independently. Processor 16 may also include an algorithm that may be trained using input features such as weather data (outdoor temperature, wind, etc.) and output features (fuel consumption). Fuel consumption can be monitored continuously though a flow meter. Data from operating the heating system (and other systems, such as ventilation) can be recorded and used in perfecting the processor algorithm.

It is to be understood that what has been described are the preferred embodiments of the present disclosure. The scope of the claims should not be limited by the preferred embodiments set forth above, but should be given the broadest interpretation consistent with the description as a whole.

1. A radiant brooder system comprising:
a first multistage radiant brooder configured to emit radiant heat to a floor area to create a first temperature zone, the first multistage radiant brooder having a high output setting and a low output setting;
a first black body sensor positioned to gather radiant energy data within the first temperature zone; and
a processor coupled to the first black body sensor to receive the radiant energy data therefrom, and operatively coupled to the first multistage radiant brooder to control operation of the first multistage radiant brooder between the high output setting, the low output setting, and an off setting in response to the received radiant energy data from the first black body sensor.

2. The radiant brooder system of claim 1, further comprising a second multistage radiant brooder, the second multistage radiant brooder being positioned adjacent the first multistage radiant brooder and coupled to the processor.

3. The radiant brooder system of claim 2, wherein the processor controls the first multistage radiant brooder independently from the second multistage radiant brooder.

4. The radiant brooder system of claim 3, further comprising a second black body sensor positioned to determine radiant energy data in a second temperature zone created by the second multistage radiant brooder, the processor coupled to the second black body sensor to receive the radiant energy data therefrom, and configured to control the second multistage radiant brooder in response to the received radiant energy data from the second black body sensor.

5. The radiant brooder system of claim 2, wherein the first and second multistage radiant brooders form a first pair of radiant brooders, the processor being configured to control the first and second multistage radiant brooders together to collectively create the first temperature zone.

6. The radiant brooder system of claim 5, further comprising:
a second pair of radiant brooders, and a second black body sensor positioned to determine radiant energy data in a second temperature zone created by the second pair of radiant brooders;
wherein the processor is coupled to the second black body sensor to receive the radiant energy data therefrom, and is operatively coupled to the second pair of radiant brooders to control operation of the second pair of radiant brooders independently from the first pair of radiant brooders.

7. The radiant brooder system of claim 1, further comprising a solar air collector integrated into a wall of a building housing the radiant brooder system, the solar air collector configured to preheat external air coming into the building using solar energy.

8. The radiant brooder system of claim 7, further comprising a fresh air controller secured proximate to the solar air collector, and further comprising an incoming air temperature sensor, the fresh air controller configured to control an amount of the preheated incoming external air entering the building, the processor coupled to the fresh air controller to control the operation of the fresh air controller, the processor coupled to the incoming air temperature sensor.

9. The radiant brooder system of claim 1, further comprising a humidity sensor to sense humidity levels in a building housing the radiant brooder system, the processor coupled to the humidity sensor to receive the humidity levels and to control humidity within the building through controlling the first multistage brooder.

10. The radiant brooder system of claim 9, further comprising an outdoor temperature sensor configured to determine an ambient temperature outside a building housing the radiant brooder system, the processor coupled to the outdoor temperature sensor to receive outdoor ambient temperature data therefrom.

11. The radiant brooder system of claim 1, further comprising a wind sensor configured to determine wind direction and speed outside a building housing the radiant brooder system, the processor coupled to the wind sensor to receive wind speed and direction data therefrom.

12. The radiant brooder system of claim 11, further comprising an occupancy sensor, the occupancy sensor configured to determine an approximate number of animals located within the first temperature zone on the floor area, the processor coupled to the occupancy sensor to receive a signal corresponding to an approximate number of animals sensed thereby, the processor further configured to calculate an amount of heat required to maintain body temperatures of the determined number of animals within a pre-determined range based on environmental conditions.

13. The radiant brooder system of claim 12, wherein the environmental conditions comprise one or more of the air temperature within a building housing the radiant brooder system, exterior building air temperature, exterior building wind direction and speed, interior building humidity levels, or incoming air temperature.

14. The radiant brooder system of claim 1, wherein the first multistage radiant brooder comprises an emitter and a reflector, the emitter being positioned about 0.2 to 0.3 inches from the reflector.

15. The radiant brooder system of claim 1, wherein the first multistage radiant brooder comprises an emitter and a reflector, about 70 to 80% of a surface of the emitter being positioned inside the reflector.

16. A radiant brooder system for heating an agricultural building, the radiant brooder system comprising:
a pair of multistage radiant brooders, each multistage radiant brooder configured to emit radiant energy to a floor area to create a first temperature zone, each multistage radiant brooder having a high output setting and a low output setting;
a pair of black body sensors, each of the black body sensors being positioned to gather radiant energy data within a respective first temperature zone of a respective multistage radiant brooder;
a solar air collector integrated into a wall of the agricultural building, the solar air collector configured to preheat external air coming into the agricultural building using solar energy; and
a processor coupled to each black body sensor to receive the radiant energy data therefrom, the processor operatively coupled to the pair of multistage radiant brooders to control the multistage radiant brooders in response to the received radiant energy data from the black body sensors.

17. The radiant brooder system of claim 16, further comprising a fresh air controller secured proximate to the solar air collector, the fresh air controller configured control and determine an amount of the preheated incoming external air entering the building, the processor coupled to the fresh air controller to control the operation of the fresh air controller.

18. The radiant brooder system of claim 17, further comprising a humidity sensor to sense humidity levels in the building, the processor coupled to the humidity sensor to receive the humidity levels and to control humidity within the building through controlling the multistage brooders.

19. The radiant brooder system of claim 18, further comprising an outdoor temperature sensor configured to determine an ambient temperature outside the building, the processor coupled to the outdoor temperature sensor to receive outdoor ambient temperature data therefrom.

20. The radiant brooder system of claim 19, further comprising a wind sensor configured to determine wind direction and speed outside the building, the processor coupled to the wind sensor to receive wind speed and direction data therefrom.

21. The radiant brooder system of claim 20, further comprising an occupancy sensor, the occupancy sensor configured to determine an approximate number of animals located on the floor area, the processor coupled to the occupancy sensor to receive a signal corresponding to an approximate number of animals sensed thereby, the processor further configured to calculate an amount of heat required to maintain body temperatures of the determined number of animals within a pre-determined range based on environmental conditions.

22. The radiant brooder system of claim 21, wherein the environmental conditions comprise one or more of the air temperature within the building, exterior building air temperature, exterior building wind direction and speed, interior building humidity levels, or incoming air temperature.
